(19) United States
(12) Patent Application Publication
(10) Pub. No.: US 2024/0344386 A1
(43) Pub. Date: Oct. 17, 2024

(54) RETRACTABLE PROTECTIVE DOOR BAR CAPABLE OF ADAPTING TO LONG CURTAIN

(71) Applicant: GUANGZHOU TUSUNNY HOME PRODUCTS CO., LTD., Guangzhou (CN)

(72) Inventor: Hongjuan WANG, Guangzhou (CN)

(21) Appl. No.: 18/332,265

(22) Filed: Jun. 9, 2023

(30) Foreign Application Priority Data
Apr. 14, 2023 (CN) 2023208516107

(51) Int. Cl. E06B 9/13; E06B 3/80; E06B 5/02

(52) U.S. Cl. CPC E06B 9/13; E06B 3/80; E06B 5/025; E06B 2009/002

(57) ABSTRACT

Provided is a retractable protective door bar capable of adapting to a long curtain. The retractable protective door bar includes an upper fixation seat, a lower fixation seat, a rolling curtain shaft and a rolling curtain subassembly. A torsional spring is mounted inside the rolling curtain shaft, a rotating subassembly and a stopping subassembly are arranged inside the lower fixation seat, the rotating subassembly has a ratchet wheel, and the stopping subassembly has a locking tooth. The rotating subassembly may rotate toward one direction only through clamping of the locking tooth and the ratchet wheel. An upper end of the torsional spring is connected and fixed to the rolling curtain shaft, and a lower end is connected and fixed to the rotating subassembly. in this way the torsion of the torsional spring may be adjusted by twisting the rotating part outside the lower fixation seat.

### TECHNICAL FIELD

The application relates to the technical field of protection products for children, and in particular to a retractable protective door bar capable of adapting to a long curtain that used for preventing an infant from walking out of a room.

### BACKGROUND

In a family having an infant, people usually mount a retractable protective door bar for an interior door to prevent loss, personal injury and other accidents caused by the infant walking out of a room. This kind of protective door bar mainly includes upper and lower fixation seats, a rolling curtain shaft, a rolling curtain subassembly and the like. The rolling curtain shaft is mounted between the upper fixation seat and the lower fixation seat, the rolling curtain subassembly is mounted on the rolling curtain shaft and may be pulled out, and the rolling curtain (also called curtain) may also be automatically scrolled through the rolling curtain shaft. The rolling curtain of the existing protective door bar is very short generally and less than 1 m. Thus, it is not suitable for a great aisle. If the great aisle needs to be provided with the protective door bar, the rolling curtain needs to be lengthened, for example, 4 m or 5 m. However, it is bound to take a large torsional spring with greater torsion to scroll such a long rolling curtain. However, if the large torsional spring is mounted with a traditional way, the following problems may occur: it is difficult to completely scroll the rolling curtain if the torsion is not great enough; when the torsion is adjusted to be able to completely scroll the rolling curtain, the scrolling speed may be too high at the beginning due to the large torsion, in this way a potential safety hazard may be caused, and the rolling curtain may be damaged easily.

### SUMMARY

In allusion to defects of the traditional art, the application aims to provide a retractable protective door bar capable of adapting to a rolling curtain, which is simple in structure, more reasonable in design, and may adjust a scrolling speed through adjusting the torsion of a torsional spring. A maximum length of the rolling curtain may be 5 m.

To solve the above-mentioned technical problem, the following technical solution is taken. A retractable protective door bar capable of adapting to a long curtain includes an upper fixation seat, a lower fixation seat, a rolling curtain shaft and a rolling curtain subassembly. An upper end of the rolling curtain shaft is connected to the upper fixation seat, and a lower end is connected to the lower fixation seat. The rolling curtain subassembly is connected to the rolling curtain shaft, a torsional spring is mounted inside the rolling curtain shaft, and the rolling curtain shaft may rotate through the torsion of the torsional spring to automatically scroll the rolling curtain subassembly. Herein, a rotating subassembly and a stopping subassembly are arranged inside the lower fixation seat, the rotating subassembly has a ratchet wheel, and the stopping subassembly has a locking tooth. A structure capable of rotating toward one direction only is formed by the rotating subassembly through clamping of the locking tooth and the ratchet wheel. An upper end of the torsional spring is connected and fixed to the rolling curtain shaft, and a lower end is connected and fixed to the rotating subassembly. The rotating subassembly has an adjusting structure exposed on the lower fixation seat. The rotating subassembly is twisted through the adjusting structure to realize adjustment of the torsion of the torsional spring.

Further, the rotating subassembly includes a rotating part and a lower fixation head. The ratchet wheel is positioned on a circumferential surface of the rotating part, the lower fixation head is mounted on the rotating part, and the lower end of the torsional spring is connected and fixed to the lower fixation head. A bottom surface of the rotating part is provided with an adjusting hole which is taken as the adjusting structure, and a screwdriver may be inserted into the adjusting hole to twist the rotating part.

Further, the lower fixation seat further includes a seat body and a bottom cover. A mounting hole is arranged on the seat body, the rotating part is mounted inside the seat body through the mounting hole, a through hole is arranged inside the bottom cover, the bottom cover is fixedly connected to the seat body and accordingly covers the ratchet wheel, and the through hole is aligned with the adjusting hole.

Further, the locking tooth is arranged on a side of a locking arm, and the locking arm is mounted inside the seat body through a fixation shaft. A first spring is arranged inside the seat body, and abutted against the locking arm, in this way the locking tooth and the ratchet wheel are kept in a clamped state.

Further, a rolling curtain which is 2-5 m long is taken as the rolling curtain subassembly, and a spring having the torsion greater than that of a traditional rolling curtain about 1 m is taken as the torsional spring.

Further, a side wall of the lower fixation head is provided with a hanging hole, and the lower end of the torsional spring is provided with a hook. The torsional spring is hung on the hanging hole through the hook, in this way connection and fixation to the lower fixation head is realized.

Further, the upper end of the torsional spring is connected and fixed to an upper fixation head, and the upper fixation head is fixed at a position of an upper-middle section of the rolling curtain shaft through a screw.

Further, a knob adjusting subassembly for rotating the rolling curtain shaft to adjust the degree of tightness of the rolling curtain subassembly is arranged inside the upper fixation seat.

Further, the knob adjusting subassembly includes a locking apparatus, an unlocking subassembly and an adjusting knob. The locking apparatus includes a locking ratchet wheel, a locking pawl and a second spring. A lower end of the locking ratchet wheel is connected to the upper end of the rolling curtain shaft, the locking pawl matches up with the locking ratchet wheel, the second spring may drive the locking pawl to keep and insert into a tooth slot inside the locking ratchet wheel, an upper section of the locking ratchet wheel is provided with the adjusting knob, and the unlocking subassembly is used for separating the locking pawl from the tooth slot in the locking ratchet wheel.

Further, an upper surface of the locking ratchet wheel is provided with an upper fixation portion, and a bottom surface of the adjusting knob is provided with a fixation sleeve. The adjusting knob is connected to the locking ratchet wheel by inserting the upper fixation portion into the fixation sleeve.

Further, the adjusting knob is a round structure, and an outer circumferential surface is provided with vertical skidproof stripes.

Further, the lower end of the locking ratchet wheel is provided with a lower fixation portion. The lower fixation portion is inserted into a connector in a plug-in manner to realize connection to the connector. The connector is connected to the rolling curtain shaft.

Further, the lower fixation portion is a non-cylindrical structure. A plug-in hole with a shape matching up with the lower fixation portion is arranged inside the connector, and the lower fixation portion is inserted into the plug-in hole, in this way the connection of the locking ratchet wheel to the connector is realized.

Further, the unlocking subassembly includes a pushing rod and a pushing toggling button arranged on an upper part of the pushing rod. The pushing rod may be driven to move by pushing the pushing toggling button, and the pushing rod after moving may drive the locking pawl to separate from the tooth slot in the locking ratchet wheel.

Further, two fixation rods are arranged between the upper fixation seat and the lower fixation seat, and the two fixation rods are parallel to the rolling curtain shaft.

The rotating part is arranged inside the lower fixation seat, the lower end of the torsional spring is connected to the rotating part through the lower fixation head, the upper end is fixed to the rolling curtain shaft through the upper fixation head, in this way the torsion of the torsional spring may be adjusted by twisting the rotating part outside the lower fixation seat, and accordingly the appropriate torsion may be obtained when scrolling the rolling curtain to maintain an appropriate scrolling speed of the rolling curtain. Moreover, the potential safety hazard generated when the scrolling speed of the rolling curtain is too fast may be eliminated, and the rolling curtain may be protected from damage.

### BRIEF DESCRIPTION OF THE DRAWINGS

FIG. 1 is an overall structural diagram of the application.

FIG. 2 is an overall structural diagram of the application from another angle.

FIG. 3 is a using state diagram of a rolling curtain subassembly in the application after being drawn.

FIG. 4 is an assembling structural diagram of a rolling curtain shaft and a lower fixation seat.

FIG. 5 is an assembling structural diagram of a torsional spring and a lower fixation seat.

FIG. 6 is an exploded view of a main part of a lower fixation seat.

FIG. 7 is a schematic structural diagram of a knob adjusting subassembly.

FIG. 8 is an exploded view of a knob adjusting subassembly.

In the drawings, 1—Upper fixation seat, 10—Rolling curtain, 11—Knob adjusting subassembly, 12—Locking ratchet wheel, 13—Locking pawl, 14—Second spring, 15—Adjusting knob, 16—Upper fixation portion, 17—Fixation sleeve, 18—Lower fixation portion, 19—Connector, 20—Plug—in hole, 2—Lower fixation seat, 21—Seat body, 211—Mounting hole, 22—Rotating part, 221—Ratchet wheel, 222—Adjusting hole, 23—Lower fixation head, 231—Butt joint head, 232—Hanging hole, 24—Locking arm, 241—Locking tooth, 25—First spring, 26—Bottom cover, 27—Pushing rod, 28—Pushing toggling button, 261—Through hole, 3—Rolling curtain shaft, 4—Rolling curtain subassembly, 5—Fixation rod, 6—Torsional spring, 8—Upper fixation head, and 9—Screw.

### DETAILED DESCRIPTION OF THE EMBODIMENTS

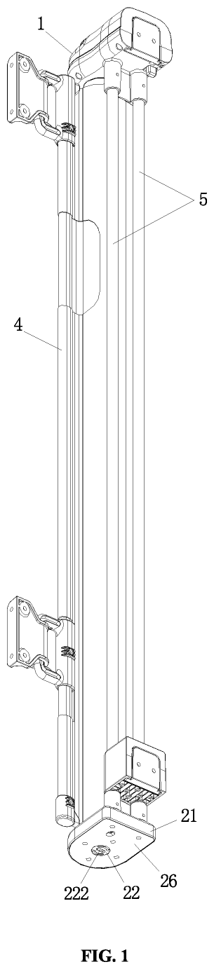

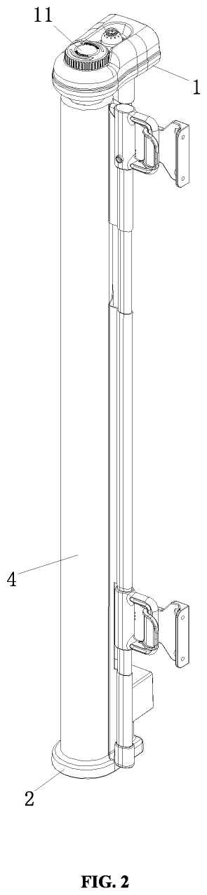

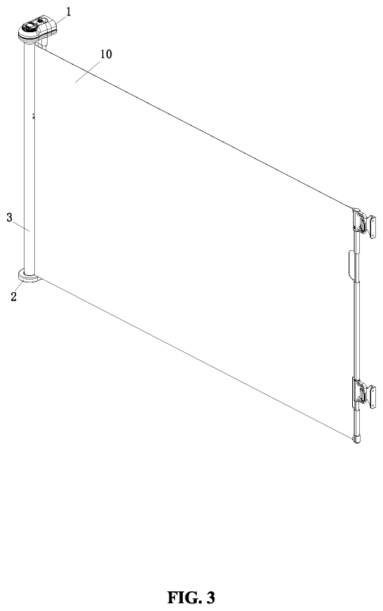

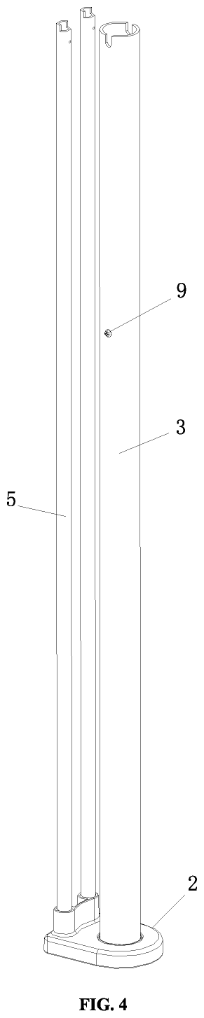

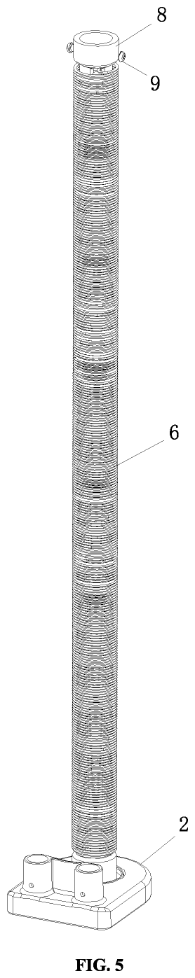

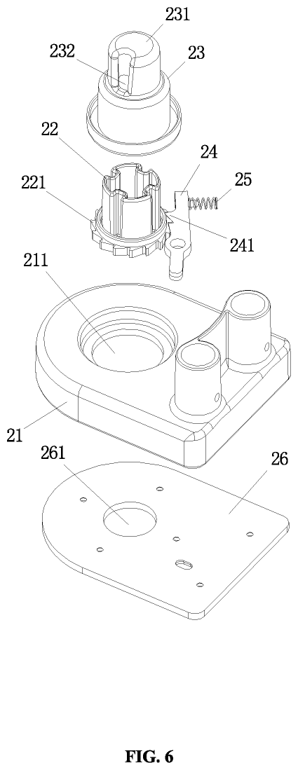

In the embodiment, with reference to FIGS. 1-6, a retractable protective door bar capable of adapting to a long curtain includes an upper fixation seat 1, a lower fixation seat 2, a rolling curtain shaft 3 and a rolling curtain subassembly 4. An upper end of the rolling curtain shaft 3 is connected to the upper fixation seat 1, and a lower end is connected to the lower fixation seat 2. The rolling curtain shaft 3 may rotate around an axis of the rolling curtain shaft 3, the rolling curtain subassembly 4 is connected to the rolling curtain shaft 3 and includes a rolling curtain 10 for protection and stopping, and the rolling curtain 10 is wound on the rolling curtain shaft 3. A torsional spring 6 is mounted inside the rolling curtain shaft 3, and the rolling curtain shaft 3 may realize one-way rotation through the torsion of the torsional spring 6 to automatically scroll the rolling curtain 10 in the rolling curtain subassembly 4. A rotating subassembly and a stopping subassembly are arranged inside the lower fixation seat 1, the rotating subassembly has a ratchet wheel 221, and the stopping subassembly has a locking tooth 241. A structure capable of rotating toward one direction only is formed by the rotating subassembly through clamping of the locking tooth 241 and the ratchet wheel 221. An upper end of the torsional spring 6 is connected and fixed to the rolling curtain shaft 3, and a lower end is connected and fixed to the rotating subassembly. The rotating subassembly has an adjusting structure exposed on the lower fixation seat 2. The rotating subassembly is twisted through the adjusting structure to realize adjustment of the torsion of the torsional spring 6.

Specifically, the rotating subassembly includes a rotating part 22 and a lower fixation head 23. The ratchet wheel 221 is positioned at a lower portion of the rotating part 22, and the lower fixation head 23 is mounted on the rotating part 22 and may rotate together with the rotating part 22. The lower end of the torsional spring 6 is connected and fixed to the lower fixation head 23. A bottom surface of the rotating part 22 is provided with an adjusting hole 222 which is taken as the adjusting structure, and a screwdriver may be inserted into the adjusting hole 222 to twist the rotating part 22. The upper end of the torsional spring 6 is connected and fixed to an upper fixation head 8, and the upper fixation head 8 is fixed at a position of an upper-middle section of the rolling curtain shaft 3 through a screw 9.

The lower fixation seat 2 further includes a seat body 21 and a bottom cover 26. A mounting hole 211 is arranged on the seat body 21, the rotating part 22 is mounted inside the seat body 21 through the mounting hole 211, a through hole 261 is arranged inside the bottom cover 26, the bottom cover 26 is fixedly connected to the seat body 21 and accordingly covers the ratchet wheel 221, and the through hole 261 is aligned with the adjusting hole 222. The screwdriver may be inserted into the adjusting hole 222 after going through the through hole 261 to twist the rotating part 22.

The locking tooth 241 is arranged on a side of a locking arm 24, and the locking arm 24 is mounted inside the seat body 21 through a fixation shaft. A first spring 25 is arranged inside the seat body 21, and abutted against the locking arm 24 to keep the locking tooth 241 and the ratchet wheel 221 in a clamped state. In this way, the rolling curtain shaft 3 may rotate anticlockwise only along with the locking tooth 241 rather than rotate against the locking tooth 241, to ensure that the torsion of the torsional spring 6 is not released.

The rolling curtain subassembly 4 includes the rolling curtain 10 of 2-5 m long, and a spring having the torsion greater than that of a traditional rolling curtain about 1 m is taken as the torsional spring 6.

A side wall of the lower fixation head 23 is provided with a hanging hole 232, and the lower end of the torsional spring 6 is provided with a hook. The torsional spring 6 is hung on the hanging hole 232 through the hook, in this way connection and fixation to the lower fixation head 23 is realized.

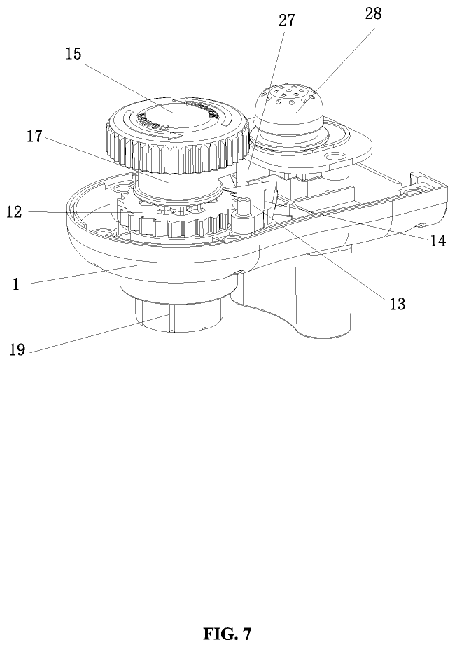

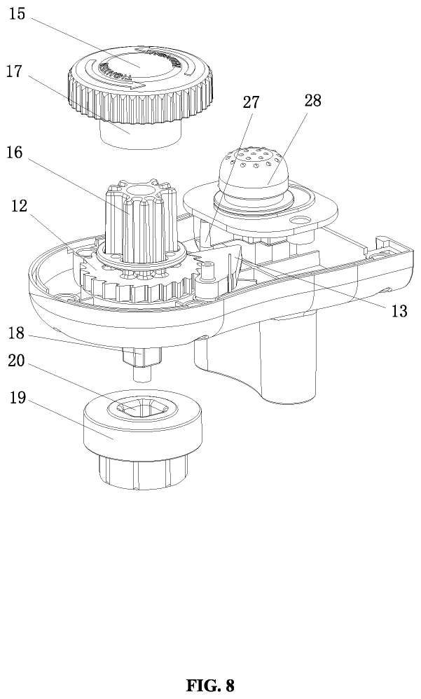

As shown in FIGS. 7-8, a knob adjusting subassembly 11 for rotating the rolling curtain shaft 3 to adjust the degree of tightness of the rolling curtain in the rolling curtain subassembly 4 is arranged inside the upper fixation seat 1. Specifically, the knob adjusting subassembly 11 includes a locking apparatus, an unlocking subassembly and an adjusting knob. A user needs to lock a position of the rolling curtain 10 after pulling out the rolling curtain 10 from the rolling curtain shaft 3 for a certain length, to prevent the rolling curtain 10 from being further pulling out from the rolling curtain shaft 3. The locking apparatus may be taken to realize locking. A structure of the locking apparatus is further described below. In the embodiment, the locking apparatus is arranged inside the upper fixation seat 1.

The locking apparatus includes a locking ratchet wheel 12. A lower end of the locking ratchet wheel 12 is connected to the upper end of the rolling curtain shaft 3. Specifically, in the embodiment, the lower end of the locking ratchet wheel 12 is provided with a lower fixation portion 18. The lower fixation portion 18 is inserted into a connector 19 through a plug-in way, in this way connection to the connector 19 is realized. The connector 19 is connected to the rolling curtain shaft 3. More specifically, the lower fixation portion 18 is a non-cylindrical structure. A plug-in hole 20 with a shape matching up with the lower fixation portion 18 is arranged inside the connector 19, and the lower fixation portion 18 is inserted into the plug-in hole 20, in this way the connection of the locking ratchet wheel 12 to the connector 19 is realized. The lower fixation portion 18 is a structure having a square cross section, and the plug-in hole 20 is a square hole.

The locking apparatus further includes a locking pawl 13 matching up with the locking ratchet wheel. The upper fixation seat 1 is provided with a rotating shaft in a raised manner. The locking pawl is sleeved on the rotating shaft through a through hole arranged on the locking pawl, in this way the locking pawl 13 rotates around an axis of the rotating shaft. The locking apparatus further includes a second spring 14. The second spring 14 drives the locking pawl 13 to keep a trend of inserting into a tooth slot inside the locking ratchet wheel 12.

From the locking apparatus, the locking ratchet wheel 13 may rotate only along with one direction around the axis of the locking ratchet wheel 13 due to limitation of the locking pawl 13, i.e. the locking ratchet wheel 13 may not rotate anticlockwise and rotate clockwise. In the embodiment, before the locking pawl 13 is inserted into the tooth slot in the locking ratchet wheel 12, the rolling curtain 10 may be pulled out from the rolling curtain shaft 3. At the moment, the rolling curtain shaft 3 rotates clockwise, and the locking ratchet wheel 12 also rotates clockwise and may not limit rotation of the locking ratchet wheel 12. When the rolling curtain 10 needs to be locked to prevent the rolling curtain 10 from being further pulled out, a second spring may be used. The second spring 14 drives the locking pawl 13 to be inserted into the tooth slot inside the locking ratchet wheel 12, and the locking pawl 13 limits the locking ratchet wheel 12, in this way the locking ratchet wheel 12 may not rotate clockwise any longer, i.e. the rolling curtain 10 may not be further pulled out. It is to be noted that the locking ratchet wheel 12 is not limited by the locking pawl 13 to rotate anticlockwise, the scrolling force is always exerted to the rolling curtain 10 due to the torsion of the torsional spring. The rolling curtain 10 may be kept in a strained state however it is limited to be further pulled out.

If the user needs to remove the locking of the rolling curtain 10, the unlocking subassembly may be used. A structure of the unlocking subassembly is further described below. In the embodiment, the unlocking subassembly includes a pushing rod 27 and a pushing toggling button 28 arranged on an upper part of the pushing rod. The pushing rod 27 may be driven to move by pushing the pushing toggling button 28, and the pushing rod 27 after moving may drive the locking pawl 13 to separate from the tooth slot inside the locking ratchet wheel 12, to remove the locking of the rolling curtain 10. The pushing toggling button 28 is toggled to reset. The second spring 14 may drive the locking pawl 13 to make the locking pawl 13 to be inserted into the tooth slot inside the locking ratchet wheel 12 again, in this way the rolling curtain 10 is locked again.

An upper section of the locking ratchet wheel is provided with an adjusting knob 15. Specifically, an upper surface of the locking ratchet wheel 12 has an upper fixation portion 16, a bottom surface of the adjusting knob 15 has a fixation sleeve 17, and the adjusting knob 15 is connected to the locking ratchet wheel 12 by inserting the upper fixation portion 16 into the fixation sleeve 17. The adjusting knob 15 is a round structure, and an outer circumferential surface is provided with vertical skidproof strips. The adjusting knob 15 is twisted to rotate anticlockwise, to drive the locking ratchet wheel 12 to rotate anticlockwise. The locking ratchet wheel 12 may separate from a meshing state with the locking pawl 13 after rotating anticlockwise. The locking pawl 13 prevents the locking ratchet wheel 12 from rotating clockwise only. Therefore, the adjusting knob 15 is rotated to rotate anticlockwise, in this way the rolling curtain shaft 3 rotates, and accordingly the rolling curtain 10 is scrolled and strained, and the phenomenon that the rolling curtain 10 is loose after being drawn may be avoided.

Two fixation rods 5 are arranged between the upper fixation seat 1 and the lower fixation seat 2, and the two fixation rods 5 are parallel to the rolling curtain shaft 3. Moreover, a big space is designed between the two fixation rods 5 and the rolling curtain shaft 3, in this way such a long rolling curtain may be accommodated.

The above describes the application in detail, and is only the preferred embodiment of the application and not intended to limit the scope of implementation of the application. Any equivalent modifications and improvements on the basis of the scope of the application shall fall within the scope of the application.

1. A retractable protective door bar capable of adapting to a long curtain, comprising an upper fixation seat, a lower fixation seat, a rolling curtain shaft and a rolling curtain subassembly, an upper end of the rolling curtain shaft being connected to the upper fixation seat, and a lower end being connected to the lower fixation seat; the rolling curtain subassembly being connected to the rolling curtain shaft, a torsional spring being mounted inside the rolling curtain shaft, and the rolling curtain shaft rotating through the torsion of the torsional spring to automatically scroll a rolling curtain inside the rolling curtain subassembly, wherein, a rotating subassembly and a stopping subassembly are arranged inside the lower fixation seat, the rotating subassembly has a ratchet wheel, and the stopping subassembly has a locking tooth; a structure capable of rotating toward one direction only is formed by the rotating subassembly through clamping of the locking tooth and the ratchet wheel; an upper end of the torsional spring is connected and fixed to the rolling curtain shaft, and a lower end is connected and fixed to the rotating subassembly; the rotating subassembly has an adjusting structure exposed on the lower fixation seat; and the rotating subassembly is twisted through the adjusting structure to realize adjustment of the torsion of the torsional spring.

2. The retractable protective door bar capable of adapting to the long curtain as claimed in claim 1, wherein, the rotating subassembly comprises a rotating part and a lower fixation head, the ratchet wheel is positioned on a circumferential surface of the rotating part, the lower fixation head is mounted on the rotating part, the lower end of the torsional spring is fixed and connected to the lower fixation head, and a bottom surface of the rotating part is provided with an adjusting hole.

3. The retractable protective door bar capable of adapting to the long curtain as claimed in claim 2, wherein, the lower fixation seat further comprises a seat body and a bottom cover, a mounting hole is arranged on the seat body, the rotating part is mounted inside the seat body through the mounting hole, a through hole is arranged inside the bottom cover, the bottom cover is fixedly connected to the seat body and accordingly covers the ratchet wheel, and the through hole is aligned with the adjusting hole.

4. The retractable protective door bar capable of adapting to the long curtain as claimed in claim 3, wherein, the locking tooth is arranged on a side of a locking arm, the locking arm is mounted inside the seat body through a fixation shaft, a first spring is arranged inside the seat body, and the first spring is abutted against the locking arm, in this way the locking tooth and the ratchet wheel are kept in a clamped state.

5. The retractable protective door bar capable of adapting to the long curtain as claimed in claim 1, wherein, the rolling curtain subassembly comprises the rolling curtain of 2-5 m long.

6. The retractable protective door bar capable of adapting to the long curtain as claimed in claim 2, wherein, a side wall of the lower fixation head is provided with a hanging hole, the lower end of the torsional spring is provided with a hook, and the torsional spring is hung on the hanging hole through the hook, in this way connection and fixation to the lower fixation head is realized.

7. The retractable protective door bar capable of adapting to the long curtain as claimed in claim 1, wherein, the upper end of the torsional spring is connected and fixed to an upper fixation head, and the upper fixation head is fixed at a position of an upper-middle section of the rolling curtain shaft through a screw.

8. The retractable protective door bar capable of adapting to the long curtain as claimed in claim 1, wherein, a knob adjusting subassembly for rotating the rolling curtain shaft to adjust the degree of tightness of the rolling curtain in the rolling curtain subassembly is arranged inside the upper fixation seat.

9. The retractable protective door bar capable of adapting to the long curtain as claimed in claim 1, wherein, the knob adjusting subassembly comprises a locking apparatus, an unlocking subassembly and an adjusting knob; the locking apparatus comprises a locking ratchet wheel, a locking pawl and a second spring; a lower end of the locking ratchet wheel is connected to the upper end of the rolling curtain shaft, the locking pawl matches up with the locking ratchet wheel, the second spring is able to drive the locking pawl to keep and insert into a tooth slot inside the locking ratchet wheel, an upper section of the locking ratchet wheel is provided with the adjusting knob, and the unlocking subassembly is used for separating the locking pawl from the tooth slot in the locking ratchet wheel.

10. The retractable protective door bar capable of adapting to the long curtain as claimed in claim 9, wherein, an upper surface of the locking ratchet wheel is provided with an upper fixation portion, a bottom surface of the adjusting knob is provided with a fixation sleeve, and the adjusting knob is connected to the locking ratchet wheel by inserting the upper fixation portion into the fixation sleeve.

11. The retractable protective door bar capable of adapting to the long curtain as claimed in claim 9, wherein, the adjusting knob is a round structure, and an outer circumferential surface is provided with vertical skidproof stripes.

12. The retractable protective door bar capable of adapting to the long curtain as claimed in claim 9, wherein, the lower end of the locking ratchet wheel is provided with a lower fixation portion, the lower fixation portion is inserted into a connector in a plug-in manner to realize connection to the connector, and the connector is connected to the rolling curtain shaft.

13. The retractable protective door bar capable of adapting to the long curtain as claimed in claim 12, wherein, the lower fixation portion is a non-cylindrical structure, a plug-in hole with a shape matching up with the lower fixation portion is arranged inside the connector, and the lower fixation portion is inserted into the plug-in hole, in this way the connection of the locking ratchet wheel to the connector is realized.

14. The retractable protective door bar capable of adapting to the long curtain as claimed in claim 9, wherein, the unlocking subassembly comprises a pushing rod and a pushing toggling button arranged on an upper part of the pushing rod, the pushing rod is driven to move by pushing the pushing toggling button, and the pushing rod after moving drives the locking pawl to separate from the tooth slot in the locking ratchet wheel.

15. The retractable protective door bar capable of adapting to the long curtain as claimed in claim 1, wherein, two fixation rods are arranged between the upper fixation seat and the lower fixation seat, and the two fixation rods are parallel to the rolling curtain shaft.
